(19) United States
(12) Patent Application Publication
(10) Pub. No.: US 2007/0190386 A1
(43) Pub. Date: Aug. 16, 2007

(54) OLEOPHOBIC INORGANIC MEMBRANES AND METHOD FOR THE PRODUCTION THEREOF

(76) Inventor: Thomas Schiestel, STUTTGART (DE)

Correspondence Address: OSTROLENK FABER GERB & SOFFEN, 1180 AVENUE OF THE AMERICAS, NEW YORK, NY, 100368403, US

(21) Appl. No.: 10/593,209

(22) PCT Filed: Mar. 13, 2005
(86) PCT No.: PCT/EP05/02747

§ 371 Date: Dec. 8, 2006

(30) Foreign Application Priority Data
Mar. 17, 2004 (DE) 10 2004 013 173.2

(51) Int. Cl. H01M 8/02; B67D 1/08; B01J 39/00

(52) U.S. Cl. 429/34; 210/660; 222/188

(57) ABSTRACT

Oleophobic inorganic membranes and a process for the preparation thereof, which can be used before fuel adsorbers of venting systems of fuel systems and which make possible separation of liquid fuel and the fuel vapor phase

The present invention relates to oleophobic inorganic membranes, in particular ceramic and metal membranes, to a process for the preparation thereof and to tank venting systems, in particular fuel adsorbers, comprising oleophobic inorganic membranes.

Combustion engines, such as internal combustion engines, fuel cells, turbines, jet engines, and the like, for motor vehicles, aircraft, ships and other mobile and stationary machines, such as lawn mowers, power saws, electric generators, and the like, generally require a fuel tank for their operation. The fuels used, such as in particular ethanol, methanol, gasoline, motor benzol and aviation turbine fuel (JP 4) but also diesel fuel, kerosene, vaporizing oil and high-boiling-point aviation turbine fuel (JP 5), naturally have, under standard conditions, a high vapor pressure and boiling point ranges lying in the range from approximately 30° C. Fuel vapors, in particular reinforced by the increase in the surface area occurring in mobile systems by mechanical mixing of the liquid fuel or by warming thereof, are accordingly formed in the tank systems, which fuel vapors can already exert, under normal operation, a considerable pressure on the tank systems and the fuel system. In order to prevent leakage or bursting, appropriate pressure compensation must accordingly be provided for in tank systems and fuel systems.

As is known, pressure compensation is achieved via an expensive venting system, in which, first, in particular based on various floats and siphons, the liquid is supposed to be separated from the troublesome vapor, in order to prevent liquid fuel from escaping. Legislation on protection from emissions forbids the escape of fuel vapors from the tank system into the environment, in particular for fuels for internal combustion engines in motor vehicles. Accordingly, the venting system is generally implemented as a closed system. It is advisable for an adsorption section to follow the venting system of the tank system. Such an adsorption section comprises a fuel adsorber which binds the escaping vapors. According to demand, feeding of the bound fuel vapors to the combustion is guaranteed by “flushing” the adsorber material with, for example, fresh air.

In order to prevent disadvantageous rapid overloading of the fuel adsorber by contact of the adsorber with liquid fuel, measures have to be taken to avoid contact between liquid fuel and the fuel adsorber.

In addition to the tank systems for fuels for mobile and stationary combustion engines, this problem also occurs with other tank systems or reactors with the use of highly volatile media, for example in the production and storage of organic solvents or in fuel refineries.

The technical problem underlying the present invention correspondingly consists essentially in making available means and processes which make possible an improved and simpler separation of the liquid phase and of the vapor phase of organic solvents, in particular of fuels for internal combustion engines. In this connection, in particular, simple pressure compensation should be made possible or the disadvantageous contact between the liquid phase and an adsorber for the vapor phase, in particular a fuel adsorber, should be avoided.

The underlying technical problem is solved by making available a process for the preparation of an oleophobic inorganic membrane. The process is characterized according to the invention in that an inorganic membrane is surface-modified with at least one perfluoroalkyl compound and in that an oleophobic inorganic membrane is thus obtained.

The Inventors have found, surprisingly, that the oleophobic inorganic membranes obtained by the process according to the invention are very poorly wetted by liquid fuel. If the oleophobic inorganic membrane obtained according to the invention is preferably synthesized in porous fashion, the liquid fuel can nevertheless only pass through the membrane under extremely high pressures. On the other hand, the fuel vapors can diffuse through the membrane pores. Advantageously, simple separation of liquid fuel and of the vapor phase is thus made possible and pressure compensation in a tank system is easily achieved. The inorganic oleophobic membranes of the present invention are in this connection suitable in particular for separating, as component of a tank vent, vapor from liquid. The tank vent is first necessary for the pressure compensation (danger of bursting). The membranes are also suitable for separating vapor from liquid before a vapor or solvent adsorber, in order thus to prevent rapid overloading of the adsorber. Complicated siphon systems, such as those known from the state of the art, are accordingly no longer required in order to prevent escape of liquid fuel or to prevent harmful wetting of the fuel adsorbers by the liquid fuel. In a preferred embodiment, the inorganic membrane is synthesized as a porous membrane and preferably exhibits a pore size of 1 nm to 100 μm.

Particularly advantageously, the inorganic membranes used, such as ceramic or metal membranes, are inert with regard to most fuels and organic solvents. In contrast to organic polymer membranes, the inorganic membranes obtained according to the invention are stable on a long-lasting basis with regard to the action of the fuels or organic solvents. The inorganic membrane is according to the invention a ceramic membrane. In an additional preferred alternative form, the inorganic membrane is a metal membrane.

In an additional preferred embodiment, the inorganic membrane additionally exhibits hydrophilic components in the surface matrix.

Preferably, the inorganic membrane in the process according to the invention is surface-modified by the process of silanization with perfluoroalkyl compounds and an oleophobic inorganic membrane is obtained.

In an additional preferred embodiment, the inorganic membrane is surface-modified by the process of plasma coating with perfluoroalkyl compounds.

Finally, in an additional embodiment, the in organic membrane is surface-modified by the process of painting with perfluoroalkyl compounds.

An additional subject matter of the present invention is also the oleophobic inorganic membrane surface-modified with perfluoroalkyl compounds which can preferably be obtained by the process according to the invention. As shown above, the oleophobic inorganic membrane obtained can expediently be used in fuel tank systems, in venting systems, in the fuel adsorption section and before a conventional fuel adsorber, in order to obtain the technical effect found.

An additional subject matter of the present invention is also the use of the oleophobic inorganic membrane in a venting system, for example of a fuel system, in particular before a conventional fuel adsorber, or the use of the membrane in an improved fuel adsorber, thus a fuel adsorber known per se which comprises, added thereto, an inorganic oleophobic membrane of the present invention.

An additional subject matter of the present invention is also an improved fuel adsorber comprising at least one oleophobic inorganic membrane according to the invention.

An additional subject matter of the present invention is also a fuel adsorption section comprising an oleophobic inorganic membrane according to the invention and/or the improved fuel adsorber according to the invention.

Finally, an additional subject matter of the present invention is also a venting system of a fuel system comprising an oleophobic inorganic membrane according to the invention and/or an improved fuel adsorber according to the invention and/or the fuel adsorption section according to the invention.

According to the teaching of the invention, pressure compensation in a tank system can be obtained in an industrially essentially simple way by means of the oleophobic inorganic membranes surface-modified with perfluoroalkyl compounds which are made available. Pressure compensation produced in this way is accordingly also more economical and more reliable. The invention furthermore allows a reduction in weight of the tank systems and thus makes possible the construction of new improved tank systems.

1. A tank vent, comprising an oleophobic inorganic membrane surface-modified with at least one perfluoroalkyl compound.

2. The vent according to claim 1, in which the inorganic membrane is a ceramic membrane.

3. The vent according to claim 1, in which the inorganic membrane is a metal membrane.

4. The vent according to claim 1, in which the inorganic membrane is surface-modified by silanization with at least one perfluoroalkyl compound.

5. The vent according to claim 1, in which the inorganic membrane is surface-modified by plasma coating with at least one perfluoroalkyl compound.

6. The vent according to claim 1, in which the inorganic membrane is surface-modified by painting with at least one perfluoroalkyl compound.

7. The vent according to claim 1, in which the inorganic membrane exhibits a pore size of 1 nm to 100 μm.

8. The vent according to claim 1, in which the membrane additionally exhibits hydrophilic components in the surface matrix.

9. The vent according to claim 1, in which the vent comprises a venting system of a fuel system.

10. A device for absorbing at least one of vapors and solvents, said device comprising at least one oleophobic inorganic membrane according to claim 1.

11. The device according to claim 10, wherein the device is a fuel adsorber.

12. A fuel adsorption section, comprising the fuel adsorber according to claim 11.

13. A tank system, comprising at least one device selected from the group consisting of a tank vent and a vapor or solvent absorber wherein said device comprises an oleophobic inorganic membrane surface-modifed with at least one perfluoroalkyl compound.

14. A method for separating vapor from liquid in a vapor-liquid mixture in a tank vent and/or before a vapor or solvent adsorber said method comprising contacting said mixture with an oleophobic membrane surface modified with at least one perfluoroalkyl compound.

15. The method according to claim 14, wherein the tank vent comprises a venting system of a fuel system.

16. The method according to claim 14, wherein the vapor or solvent adsorber is a fuel adsorber.

17. A process for the separation of vapor from liquid in a tank vent and/or before a vapor or solvent adsorber, which comprises locating an oleophobic inorganic membrane according to claim 1 in the tank vent or before the vapor or solvent adsorber.

18. The process according to claim 17, wherein the tank vent is a venting system of a fuel system.

19. The process according to claim 17, wherein the vapor or solvent adsorber is a fuel adsorber.
